(19) United States
(12) Patent Application Publication
(10) Pub. No.: US 2013/0277353 A1
(43) Pub. Date: Oct. 24, 2013

(54) ANDROID CONTROLLED OVEN

(71) Applicant: Dacor, Inc., City of Industry, CA (US)

(72) Inventors: Stephen A. Joseph, Newport Beach, CA (US); Ronald V. Rieger, Camarillo, CA (US); Danilo Micu, West Covina, CA (US); Miguel Estrella, Camarillo, CA (US)

(21) Appl. No.: 13/869,006

(22) Filed: Apr. 23, 2013

Related U.S. Application Data
(60) Provisional application No. 61/637,189, filed on Apr. 23, 2012.

(51) Int. Cl. H05B 1/02

(52) U.S. Cl. CPC H05B 1/0263
USPC 219/209

(57) ABSTRACT

An Android app controlled cooking oven is disclosed. The cooking oven includes a cooking chamber with temperature sensors and a heating assembly and a display panel spanning a majority of the width of the oven. A touch screen assembly is centered behind the display panel. An Android board including a cooking and controlling app and running a version of the Android operating system is included in the oven. The oven user controls the oven using the cooking and controlling app. The app assists the user in cooking and may send alerts to the user's mobile device about the status of the oven. The oven provides the user the ability to download other apps. This in turn allows the user the ability to listen to music, watch a video, access the Internet, send email and perform other actions using the oven.

### RELATED APPLICATION INFORMATION

This patent claims priority from provisional patent application 61/637,189 filed Apr. 23, 2012, the contents of which are incorporated by reference herein in their entirety.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### BACKGROUND

1. Field

This disclosure relates to cooking ovens and the control systems used in cooking ovens.

2. Description of the Related Art

Ovens are used to cook and bake various items. Ovens may be electric or gas powered and may also include a convection component. Convection ovens include one or more fans, typically in the rear of the cooking chamber, that circulate air within the cooking chamber to create convection currents. Ovens may also include a probe that senses the internal temperatures of cooked items, typically meats and poultry. And many ovens include a self-cleaning capability. To allow oven users to specify cooking time and temperature, probe temperature settings, oven cleaning options, as well as convection features, ovens include an oven controller.

As the features of ovens have increased over time, the complexity of the controller has expanded over time. Historically, oven controls included knobs and buttons. More recently ovens have included LCD displays with touch controls. The system described herein takes oven controls to a new level.

### DESCRIPTION OF THE DRAWINGS

FIG. 1 is a front perspective view illustrating an example cooking oven.

FIG. 2 is a back perspective view illustrating an example cooking oven.

FIG. 3 is a front view of an example cooking oven with the door removed.

FIG. 4 is a front view of the display panel of an oven.

FIG. 5 is an expanded view of the hardware components of a controller of an Android controlled oven.

FIG. 6 is a conceptual drawing of the hardware components of an Android controlled oven.

FIG. 7 is a screen shot of the startup screen of an Android controlled oven.

FIG. 8 is a screen shot of the startup screen of a cooking and controlling app included with an Android controlled oven.

FIG. 9 is a screen shot of a mode selection screen of a cooking and controlling app included with an Android controlled oven.

FIG. 10 is a screen shot of an example bake modes selection screen of a cooking and controlling app included with an Android controlled oven.

FIG. 11 is a screen shot of a temperature setting screen of a cooking and controlling app included with an Android controlled oven.

FIG. 12 is a screen shot of a cooking screen of a cooking and controlling app included with an Android controlled oven.

FIG. 13 is a screen shot of a guided cooking mode screen of a cooking and controlling app included with an Android controlled oven.

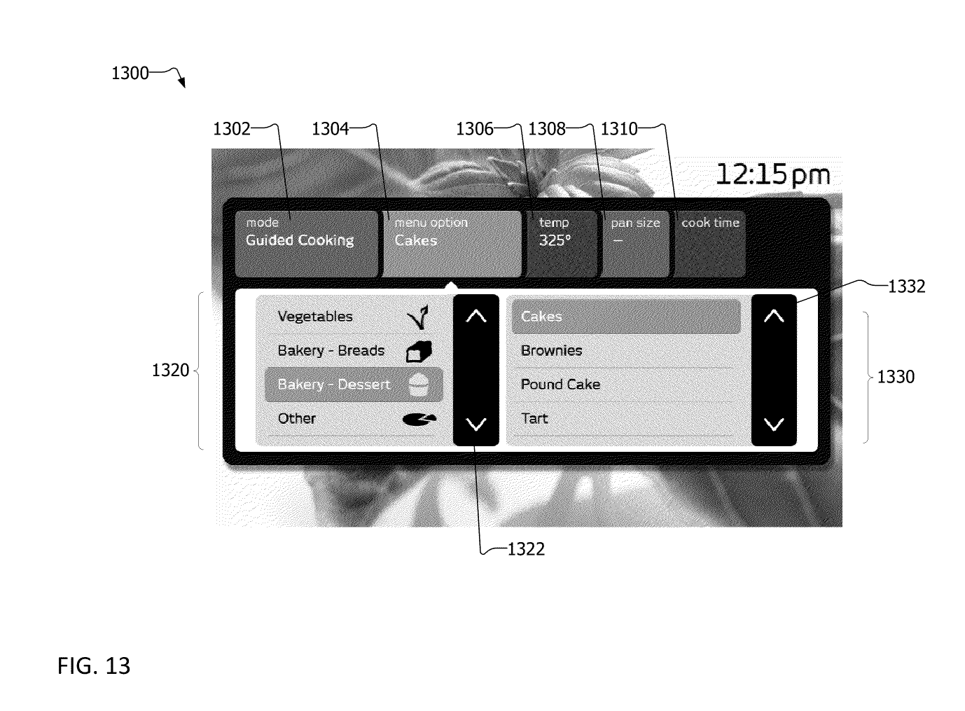

FIG. 14 is a screen shot of an updated guided cooking mode screen of a cooking and controlling app included with an Android controlled oven.

FIG. 15 is a screen shot of an example cooking screen of a cooking and controlling app included with an Android controlled oven.

FIG. 16 is a screen shot of the Android home screen showing typical Android system elements and the cooking and controlling app described herein.

An element that is not described in conjunction with a drawing may be presumed to have the same characteristics and function as a previously-described element in another drawing.

### DETAILED DESCRIPTION

Description of Apparatus

An enhanced cooking oven controlled by an included Android device running a specialized cooking and controlling app is described herein. An electric or gas oven, with or without convection and having typical oven features having electronic hardware, Android software and a cooking and controlling application included in the oven is disclosed herein. The oven also has an enhanced air moving and cooling configuration to allow for the Android control system to function in an acceptable temperature range. The Android software included in the oven is a version of the Android operating system provided by Google, Inc. of Mountain View, Calif. (As of the time of the filing this patent application Google, Inc. has a pending application to register the Android trademark. As of the filing of this patent application, the Android name is not a registered trademark for software.)

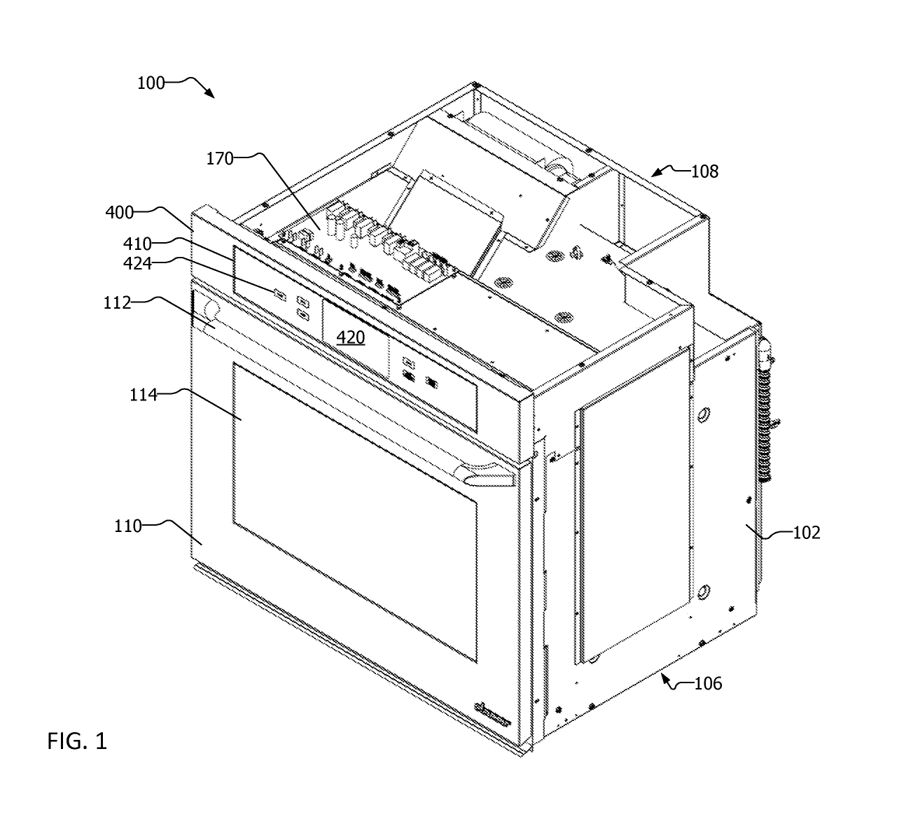

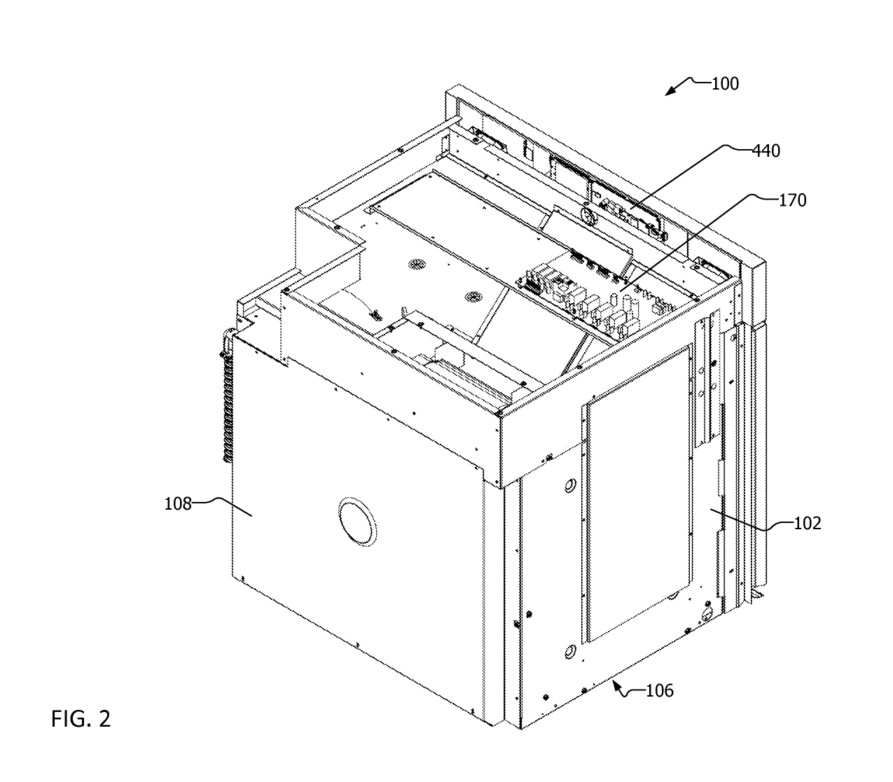

An example cooking oven is shown in FIGS. 1, 2 and 3. In these drawings, the top, bottom, left and right directions are from the perspective facing the oven door. The front is the side visible in FIG. 1 and the rear is the side opposite the front, visible in FIG. 2. Well known oven features (for example, door, hinges, racks, heating elements, power supply, energy source) are not described in detail herein so as not to distract from the key features of the Android controlled oven. The Android controlled oven described herein may include well known oven features available in ovens manufactured as of the time of filing this patent application.

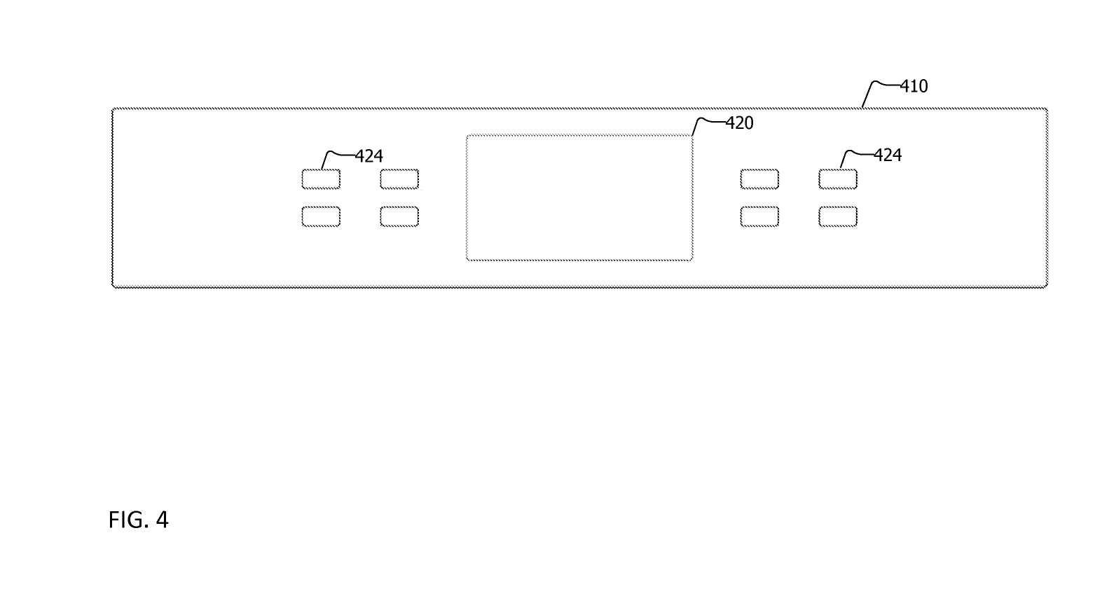

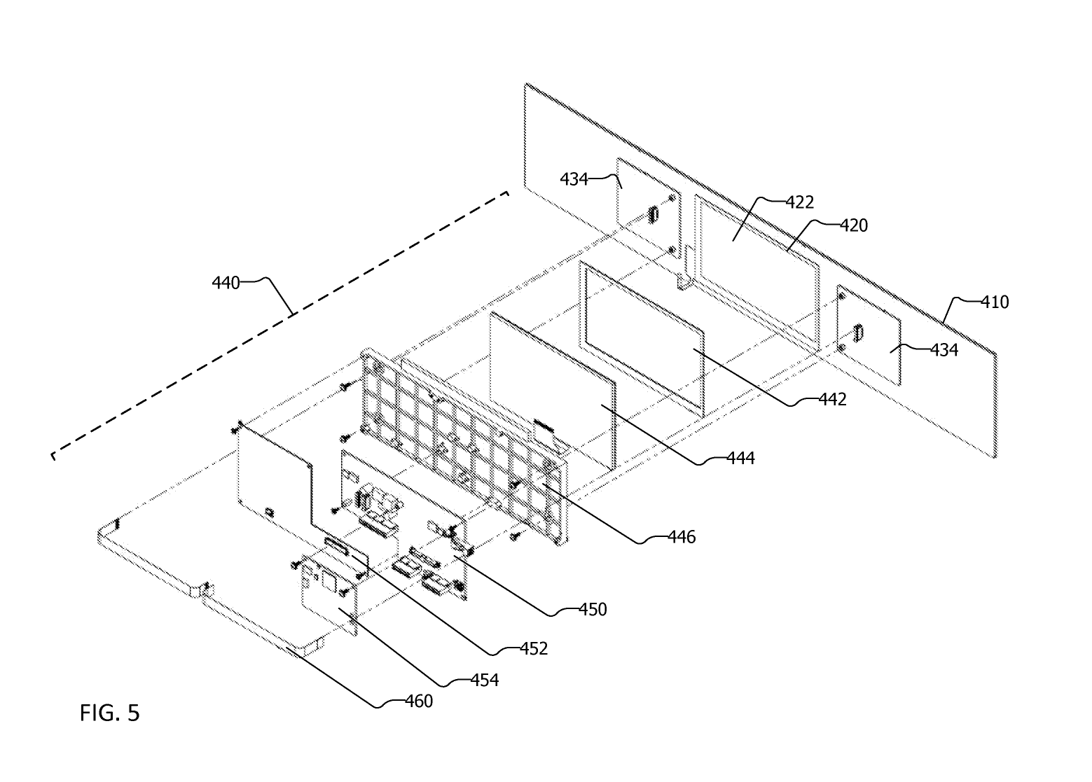

An example cooking oven 100 having a cooking chamber that is enclosed by side walls 102, a top wall (removed in this drawing so that the relay board 170 may be viewed), a bottom wall 106, a rear wall 108, and a front door 110 with handle 112 and glass window 114 is shown in FIG. 1. The oven 100 includes a front bezel 400 that includes a glass panel 410 which includes capacitive touch buttons 424 that allow a user to control certain functions of the oven and a touch screen 420 that allows a user to control the functioning of the oven, see the status of the oven, and perform various additional activities. Additional details of the functioning and content of these components are described below beginning with FIGS. 4 and 5. The area behind the front bezel 400 and glass panel 410 from the front to the back and across the width of the oven is referred to herein as the upper chamber or control chamber. The controller assembly and the relay board are included in the upper chamber.

FIG. 2 illustrates a back perspective view of the example cooking oven 100. In this drawing, the top of the oven is not depicted so that the location of the relay board 170 and controller assembly 440 may be seen.

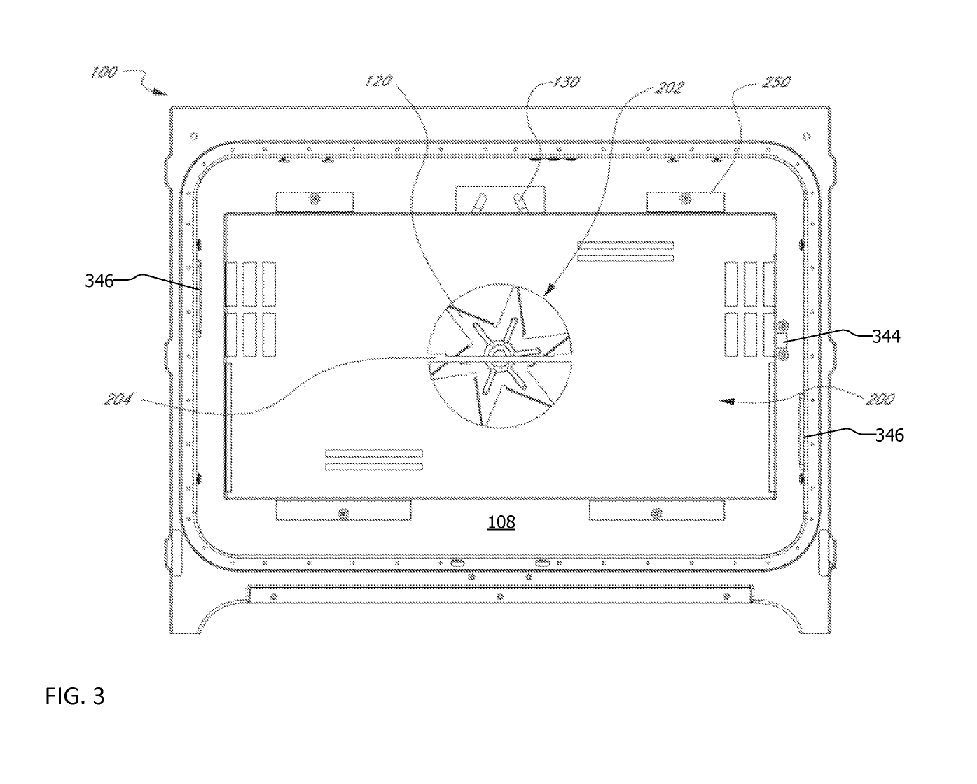

FIG. 3 is a front view of the cooking oven 100 with the front door removed for an unobstructed view of the interior of the coking chamber and in particular the interior of rear wall 108. Inside the cooking chamber and attached to the rear wall 108 is a baffle 200, which is a structure that helps distribute and circulate the air flow from the fan 120 (shown in FIG. 3). The baffle 200 surrounds the fan 120, which forces air out through vents on the baffle 200 into the cooking chamber. The positions of the vents on the baffle 200 are optimized to evenly distribute air in the cooking chamber, which results in improved cooking efficiency and uniform cooking of food.

The baffle 200 includes an inlet opening 202 where a fan 120 can draw in air and direct the airflow back out to the cooking chamber through the vents. The fan 120 may be located behind the inlet opening 202 in the baffle 200. In the illustrated embodiment, the fan 120 spins clockwise when viewed from the front to suck in air through the inlet opening 202 and force the air towards the sides of the baffle 200. In some embodiments, a filter (not shown) may be placed over the inlet opening 202 to filter the air inside the cooking chamber and help reduce cross-contamination of flavors and scents between items placed in the cooking chamber. Some convection ovens may include a heating element 130 which at least partially surrounds the fan 120 and consequently heats the air as the air stream travels through the baffle 200. The baffle 200 may be made from a piece of sheet metal that is stamped and bent into the desired shape. Additional baffle features are described in more detail in patent application Ser. Nos. 13/727,411 and 13/727,411.

The cooking oven 100 includes one or more temperature sensors 344 to obtain and provide the temperature of the interior air of the cooking chamber to various components of the oven which are described below. These sensors are coupled with the replay board 170. The cooking oven 100 includes one or more lights 346 which illuminate the interior of the cooking chamber.

The example cooking oven 100 includes a baffle to assist in the moving of air within the oven and associated chamber. However, this is only one version of an air moving configuration. Other configurations may be used to move air within the cooking and other chambers of the oven.

Referring now to FIG. 4, a front view of an example display panel 410 of an oven is shown. The display panel 410 is made of glass that must be sufficiently strong and heat resistant so as not to break or shatter in regular use. The single panel of glass is 3 mm thick and spans a significant portion of the width of the oven and may span the entire width of the oven. In one embodiment, the width of the display panel is 25″ and in another the width is almost 30″, but other widths may be used. In one embodiment, the height of the display panel 410 is 4.8″, but in other embodiments, other heights may be used. The touch screen assembly 420 allows a user to control the functioning of the oven and see the status of the oven through the glass of the display panel 410.

The majority of the glass of the display panel 410 may be opaque or blacked out such that only a rectangle size and shape of the LCD screen 444 is visible. The color of the glass may be black, white, blue or another color, so long as it is opaque but for the area used as part of touchscreen assembly 420. In the display panel 410, a rectangle that corresponds to the size of the LCD screen 444 remains clear so that users can see the information on the LCD screen 444 through the display panel 410. In the example configuration shown, the display panel 410 includes capacitive touch buttons 424 used to control the oven or provide input to the cooking and controlling app included with the Android system in the oven. Text labels specifying the function of the particular buttons as well as the shape of the capacitive touch buttons 424 are silk screened onto the glass panel 410.

The number and associated actions of the capacitive touch buttons 424 may vary based on the configuration and features of the particular oven. The example shown in FIG. 4 is used in conjunction with and included with a double wall oven. In the configuration shown, eight capacitive touch buttons 424, four on each side of touch screen 420 are shown. The capacitive touch buttons 424 in this configuration are assigned the specific actions of [1] home—takes the user to the home screen of the cooking and controlling app; [2] light—put the cooking chamber light on or off; [3] upper—select the upper oven of a double oven; [4] lower—select the lower oven of a double oven; [5] back—go back to the previous screen or action in the cooking and controlling app or other app or Android operating system action; [6] start/continue—start the oven heating feature or action selected in the cooking and controlling app or other app or Android operating system action; [7] cancel upper—stops the heating features of the upper oven; and [8] cancel lower—stops the heating features of the lower oven.

In another example configuration for a single wall oven or a single standalone oven, six capacitive touch buttons 424, three on each side of touch screen 420 are used as shown in FIG. 1. In this embodiment, the capacitive touch buttons include [1] home, [2] light, [3] menu—go to Android app list menu, [4] back, [5] start/continue, and [6] cancel. These buttons have the same or similar functionality as in the double oven configuration described in the prior paragraph. Configurations with more and fewer capacitive touch buttons may be used to control the oven and the cooking and controlling app included in the oven.

The hardware components that enable the functionality of the cooking and controlling app and the Android controlled oven are shown in an exploded view in FIG. 5. The controller assembly is included in the upper or control chamber of the oven. The aggregation of the components shown in FIG. 5 is referred to herein as the controller assembly 440. The controller assembly 440 includes, in this embodiment, touch sensitive film 422, two capacitive touch boards 434, a gasket or frame 442, an LCD screen 444, plastic carrier 446, oven interface board 450, Android board 452, and processor board 454. The oven interface board 450 is connected with the Android board 452 via a universal serial bus (USB) cable. In this way, an off the shelf or near off the shelf Android board may be used in the oven, which helps to keep oven manufacturing costs down, particularly when compared with a single board computer that ovens typically use. Other connectors as well as power supplies are not described herein as they are well known.

To enable the capacitive touch buttons 424 to receive user input via the glass display 410, two capacitive touch boards with sensors 434 are included on the back side of the glass display. The capacitive touch boards 434 are located behind (on the side opposite from) capacitive touch buttons 424 and are coupled with the oven interface board 450. A rectangular piece of touch sensitive film 422 is included in the center back portion of the glass display 410 to receive user input. Touch sensitive film 422 senses user input and sends signals to the Android board 452. Behind the touch sensitive film 422 is a liquid crystal display (LCD) 444, and there may be a gasket or frame between the LCD 444 and touch sensitive film 422. The combination of touch sensitive film 422 and LCD 444 is referred to herein as touch screen assembly 420 along with that portion of display glass 410 that corresponds in size and location with the touch sensitive film 422 and LCD 444. In one embodiment, the diagonal size of the touch sensitive film 422 and LCD 444 is seven inches. Other sized and dimensioned touch screen assemblies may be used in other embodiments. A plastic carrier 446 or support may separate the screen components from the Android board 452, oven interface board 450 and interface processor 454 and be used to stabilize the controller assembly 440. The oven interface board 450 operates in conjunction with interface processor 454.

The oven interface board 450 sends oven control instructions to the cooking elements, that is the heating and convention elements, through a relay board (shown in FIGS. 1 and 2 as element 170). The oven interface board 450 receives information from the relay board 170 about the cooking elements, door open sensor, cooking probe and temperature sensors included in the oven chamber. The oven provides oven temperature and other oven information to the user via the cooking and controlling app running on the Android board 454 via LCD 444. That is, the Android board 452 receives temperature and other oven information from the oven interface board 450 which obtains the information from the relay board (described and shown above and below as 170 and 650), and the cooking and controlling app running on the Android board 452 displays this information to the user via LCD 444.

The communication of instructions and information between the Android board 452 and the oven interface board 450 are governed by a proprietary protocol over a USB connection. Similarly, control instructions and information between the relay board 170 and the oven interface board 450 are governed by a second proprietary protocol.

The user of the oven may provide cooking and controlling instructions to the oven via the cooking and controlling app executing on the Android board through the touch screen 420 which sends user input to the Android board 452. The user input may include selection of baking/cooking method, baking/cooking temperature, convention on/off, time to cook, and others.

The Android board 452 and related components are similar to or the same as the internal components of a standard Android tablet. The Android board includes a computer processor (for example ARM CORTEX A5, A7 and A8 operating at 1, 1.2 or 1.5 GHz), a graphics processor or chip or chipset, a cache memory (random access memory (RAM)) (for example, 512 MB and 1 GB), non-volatile storage memory (for example, 2, 4, 6 8 and 16 GB), a Wi-Fi chip or chipset that enable wireless network communications supporting one or more of IEEE 802.11b/g/n, a BLUETOOTH chip or chipset to allow for communications with external portable devices (for example, mobile phones, computing tables, personal computers and portable speakers) and a programmable read only memory, electronically erasable programmable read only memory or NAND flash memory that stores firmware and the Android operating system. The Wi-Fi and Bluetooth functionality may be included in a single component or set of components included on or coupled with the Android board and may be referred to as a network communication unit. A battery may be included on the board so that the board can shut down cleanly after a power outage or other similar circumstance. The board may also include or be coupled with a sound chip and one or more audio speakers (for example one or more speakers operating at 85 db, 3 watt), an audio chip and microphone, and a video chip and multipurpose still photo and video camera (for example, 1 megapixel, 4, megapixel, etc. and 720p and 1080p resolutions). The audio speakers a microphone and/or a camera may be accessible from the front of display 410 via apertures included therein. To support wireless communication via BLUETOOTH and Wi-Fi, the Android board 452 may have an antenna included thereon or a separate antenna may be included in the controller assembly 440 and coupled with the Android board 452. The separate antenna may be a metal thin film antenna that is included in the controller assembly 440.

The Android operating system may be any current version of the Android operating system including ice cream sandwich (ver 4.0 and 4.0.x) and jelly bean (ver 4.1, 4.1.x, 4.2 and 4.2.x). The software provided on the board and with the oven may include the full breadth of apps and features typical of an Android tablet, including GMAIL, YOUTUBE, PANDORA, a web browser, and an app store for downloading additional apps. Importantly, an oven cooking and controlling app is pre-installed in the Android system.

In addition, various other apps may be preinstalled on the Android tablet or downloaded by users of the oven. There are no limits placed on the kind of apps a user may download and use on the oven. Typical apps include an audio player app (for example, PANDORA and SPOTIFY), a video player app for example, REALPLAYER), a restaurant review app (for example, YELP) and Internet phone communication software and video calling software (for example, SKYPE) may be included on the Android system or downloaded by oven users.

Providing an Android system and unrestricted use of apps allow oven users multiple advantages over typical ovens. Using the apps on the Android controlled oven, a user of the oven may listen to an audio book or favorite music and watch video (live or stored) while cooking. The user may watch a cooking video to assist in making a recipe directly on the oven's display. The user may make an audio or video call to obtain assistance from a loved one or friend while cooking (for example, a mother or grandmother giving instructions to a daughter or grandson while the daughter or grandson is using the oven or preparing a food item to be cooked in the oven).

Another use of the video and Internet features of the Android controlled oven is the ability to access streaming video from a security camera with the oven user's house. In this way, when an oven user is cooking and there is a knock on the door, the oven user may select to view a video feed from the oven user's front door security camera. This may be achieved using well known techniques, such as specifying the IP address of the entry way camera and viewing the streaming video using the web browser included in the Android operating system on the Android board in the oven. As such, the Android controlled oven is a partner in securing the oven user's home. Similarly, when the controller assembly and Android board includes a camera and related hardware and software, the camera in the oven may serve as a security camera that allows an oven user to view the interior of the oven user's kitchen when the oven user is away from home. This is achieved using well known video capturing and streaming techniques.

The Android board and related components shown and described regarding FIGS. 4 and 5 include software and hardware for providing the functionality and features described herein. The various boards shown in FIG. 5 may include one or more of: logic arrays, memories, analog circuits, digital circuits, software, firmware, and processors such as microprocessors, field programmable gate arrays (FPGAs), application specific integrated circuits (ASICs), programmable logic devices (PLDs) and programmable logic arrays (PLAs). The hardware and firmware components in the Android board and related components may include various specialized units, circuits, software and interfaces for providing the functionality and features described herein. The processes, functionality and features may be embodied in whole or in part in software which operates on the Android board as an application program or app.

The instructions from the Android board 452 and the capacitive touch buttons 424 are used to control the cooking and other features of the oven. For example, the cancel upper button and cancel lower button 424 are coupled via the capacitive touch boards 434 and the oven interface board 450 with the relay board 170/650 to immediately stop the heating elements of the particular oven from functioning. In this way, the cancel button or buttons provides a safety bypass of the Android board and cooking and controlling app to allow a user of the oven to shut off the heating element of the oven. In this same way the light button 424 is coupled via a capacitive touch board 434 via the oven interface board 450 with the relay board 170/650 to set the oven light or lights included in the oven chamber to on or off.

Similarly, instructions from a cooking and controlling app on the Android board 452 send cooking and controlling instructions to the heating and other elements in the oven chamber via the oven interface board 450 through the relay board 170/650.

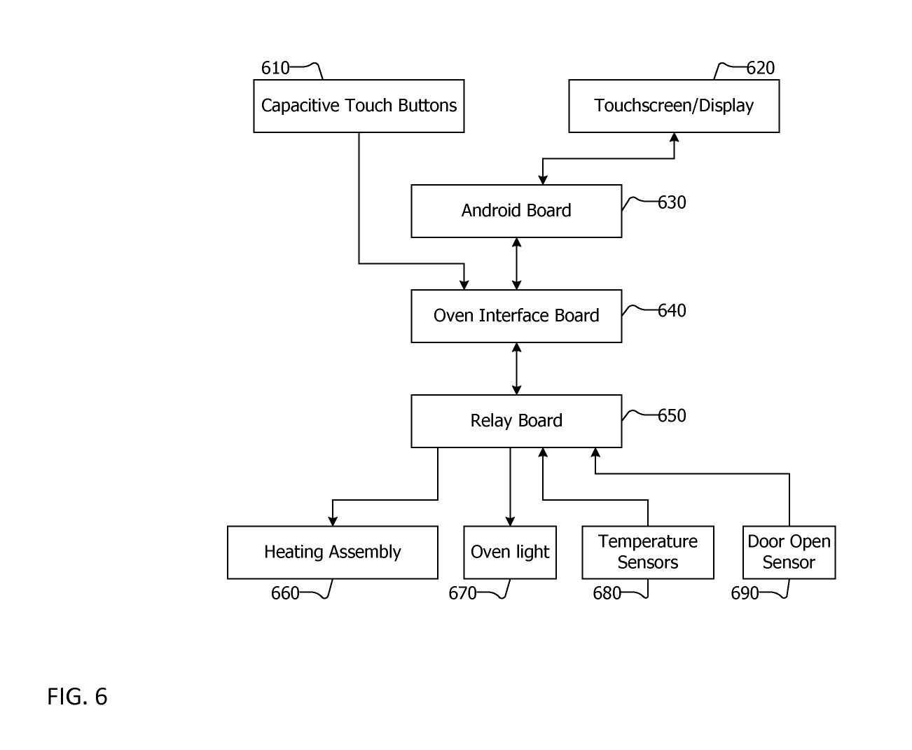

Referring now to FIG. 6, a conceptual drawing of the hardware components of an Android controlled oven is shown. In addition to the components shown in FIG. 5, a relay board (shown as element 170 in FIGS. 1 and 2) is located between the oven interface board 450 and the heating elements. The relay board provides instructions received from the capacitive touch buttons and the cooking and controlling app via the oven interface to the heating elements, light and, in some embodiments, other components located in the cooking chamber of the oven (for example a rotisserie). The relay board 650 includes an analog to digital converter to process temperature data and provide it in a usable form to the oven interface board.

The user provides instructions to and views information about the oven from the cooking and controlling app running on the Android board 630 via the touchscreen and LCD display 620. The configuration of the oven includes a relay board 650 to, on a lower level, handle possible runaway or exceptional conditions. For example, if the relay board 650 detects that the temperature of one or more temperature sensors 680 is too high or too high for too long, the relay board 650 may shut down the heating assembly 660. In the typical operation of the oven, the user provides commands using the capacitive touch buttons 610 and touch screen 620 to the Android board 630. However, should the commands provided from the Android board request cooking at a too high temperature or a too high temperature for too long, the relay board 650 could step in and send an error code back to the Android board 630 through the oven interface board 640. That is, the relay board 650 could block the instruction from being provided to the heating assembly 660. For example, if the instruction from the Android board 630 was somehow corrupted to recite cooking at 1,200 degrees Fahrenheit. The relay board 650 may detect that the temperature is out of bounds and send an error code to the Android board 630 through the oven interface board 640.

Certain of the capacitive touch buttons provide input to the oven interface board 640 through the relay board to immediately stop the heating assembly 660 of the particular oven from functioning. In this way, the cancel button or buttons provides a safety bypass of the Android board and cooking and controlling app to allow a user of the oven to shut off the heating element of the oven. In this same way the light button 610 is coupled via the relay board 650 and oven interface board 640 to set the oven light included in the oven chamber to on or off. Further, the oven may detect via a door open sensor 690 that the door is open. In this situation, the relay board 630 automatically stops the convention fan by sending a command to the heating assembly 660 and passes the door open code through the oven interface board 640 to the Android board 630. The cooking and controlling app on the Android board 630 then displays a current status condition on the display 620 and may also issue an audible alert. The oven cooking chamber air temperature is relayed in the same manner.

Description of Processes

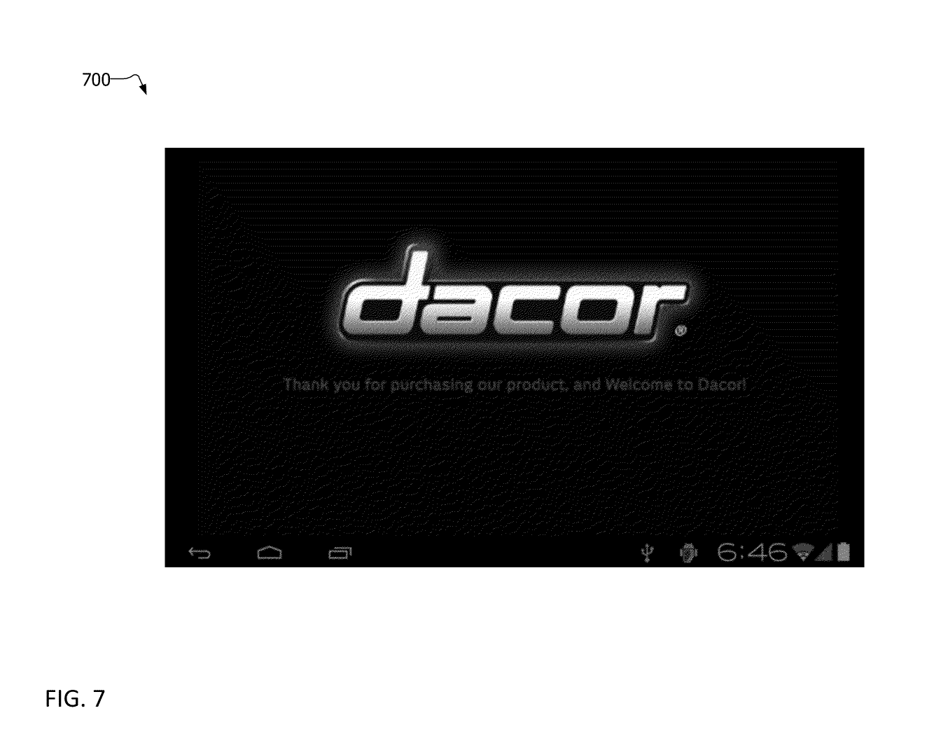

The Android controlled oven described herein includes the Android operating system. FIG. 7 is a screen shot of the startup screen 700 of an Android controlled oven. The Android control icons and system information icons typically accessible in an Android tablet are displayed in a bottom row on the screen as is common with Android tablet devices.

Upon initial startup of the oven, configuration of the oven is initiated. The Android software requests typical user information such as user email address, selection of a Wi-Fi network, a Wi-Fi password (if needed), BLUETOOTH pairing with speaker or an external controlling device such as a cell phone or tablet, and other information.

The cooking and controlling app may also register the oven with the manufacturer. The cooking and controlling app may obtain a unique identification number or other unique identifier from the Android board or a ROM on the Android board that identifies the oven. This unique ID may be used by the cooking and controlling app to register the oven with a server or website of the manufacturer over the Internet. Similarly, the cooking and controlling app may report service or exceptional conditions to a server of the manufacture via the Internet. In this way, service calls may be automatically placed or otherwise automated. In addition, the cooking and controlling app may keep a record of oven use and regularly report how the oven is being used to the manufacturer over the Internet. In this way, the oven allows the manufacturer to better understand oven usage habits and preferred features. In another version of the system, a separate hidden app may be included in the Android system, and the hidden app may register the oven, provide service information, and maintain and provide usage history as set forth in this paragraph.

In addition, upon initial startup, the cooking and controlling app executes and obtains current recipes and cooking configurations, including updates to the guided cooking data, from an oven manufacturer server via the Internet. The cooking and controlling app may play an introductory video tour of the oven describing the oven and software features of the particular model.

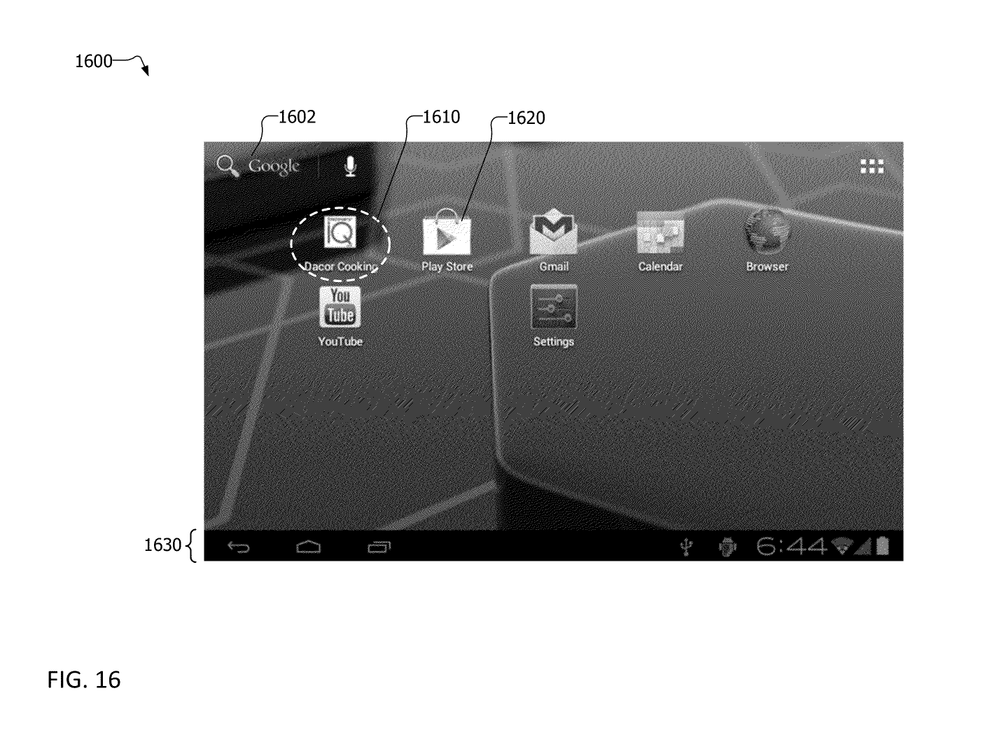

FIG. 16 is a screen shot of the Android home screen 1600 showing typical Android system elements and the cooking and controlling app 1610 described herein. On typical oven startup, the cooking and controlling app will start and take control of the display so that the Android home screen 1600 is not initially displayed. When the cooking and controlling app is running, the touchscreen allows the user to switch between the cooking and controlling app and other apps and navigate to the Android home screen. This may be done in any of the commonly used techniques, including swiping the screen horizontally to change the current window or holding down a menu soft button on the touchscreen or a menu capacitive touch button 424 on the display panel 410 that causes a list of all programs or a list of recently open programs to be displayed. In this way the user of the oven can access and download any apps the user wishes to use on the Android controlled oven.

The Android home screen may include a GOOGLE search widget 1602 accessible by text and voice and the GOOGLE PLAY store app 1620 that allows an oven user to obtain additional apps. The cooking and controlling app may be updated automatically in the oven whenever the manufacturer publishes a new version of the cooking and controlling app at the GOOGLE Play store. Similarly, over the Internet updates of the Android operating system (or components thereof) may be made via the constructs included in the Android operating system. The user of the oven may also download music and videos to the oven via the GOOGLE PLAY store accessible via the GOOGLE PLAY app 1620. Android control icons and system information icons are displayed in a bottom row 1630 on the screen.

The following description of the functioning of the Android controlled oven's cooking and controlling app refers to screen shots, all of which are displayed as part of a graphical user interface in the LCD display 444 and the touchscreen 420 described above regarding FIGS. 4 and 5. Each screen of the graphical user interfaces provided by the cooking and controlling app in the LCD display 444 through the display panel prompts the oven user to take actions by touching the touchscreen enabled display panel 410.

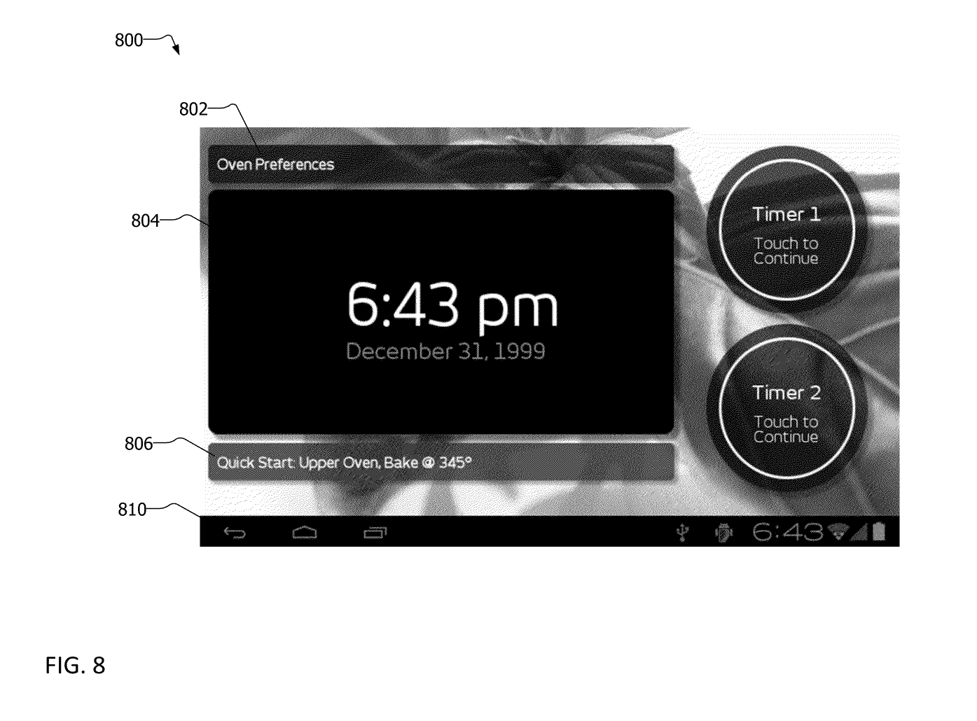

FIG. 8 is a screen shot of the startup screen 800 of a cooking and controlling app included with the Android controlled oven. This screen may automatically be displayed after initial configuration when the oven is powered on or the Android system in the oven is restarted. Android control icons and system information icons may be displayed in a bottom row 810 or not, depending on the configuration. The cooking and controlling app startup screen 800 may display an oven preferences icon/text label 802 a clock 804, and a quick start icon/text label 806. The content of the cooking and controlling app may include other or different content depending on the configuration of the system by the manufacturer. Certain items on the cooking and controlling app startup screen may be user configurable and the content of cooking and controlling app startup screen may be user configurable. For example, the cooking and controlling app startup screen may include one or more quick start icons, buttons or text labels. The quick start feature allows a user to elect to readily set the oven to a commonly used configuration of temperature, cooking, mode, etc. In the example shown, quick start 806 states “upper oven bake at 345 degrees.” When the user touches quick start 806, the cooking and controlling app will provide a cooking screen which prompts the user to confirm the oven should begin cooking according to the configuration specified in the quick start selection.

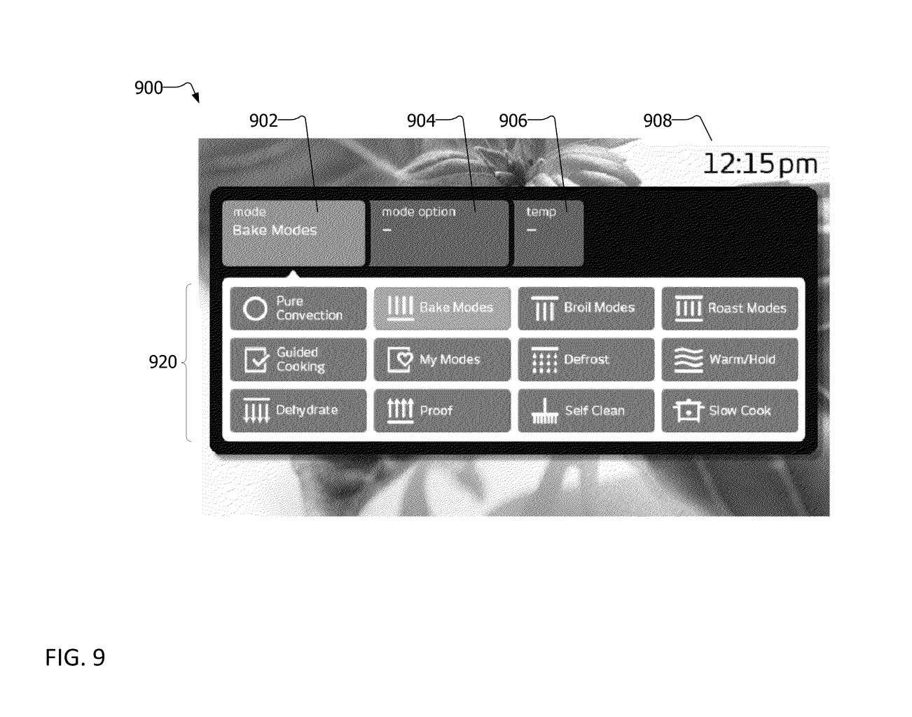

When the oven preferences icon/text label 802 is touched by a user, a cooking mode selection screen is provided to a user. In the typical operation of the Android controlled oven, when the cooking and controlling app is running, the touchscreen provides the user the ability to select from a multiplicity of cooking modes. A screen shot of a mode selection screen 900 is shown in FIG. 9. The mode selection screen 900 allows the user the ability to select from among cooking modes, including, for example, pure convection, bake modes, broil modes, roast modes, guided cooking, user stored modes (displayed by the short hand “my modes”), defrost, warm/hold, dehydrate, proof, self clean, and slow cook. Other versions may have more or fewer modes. The touch screen display provides the user the ability to select a cooking mode by tapping on the screen. As shown in FIG. 9, when a selection is made, the user interface of the cooking and cleaning app changes the color of the selected mode so that is stands out. In this version of the app, the color changes from grey to blue.

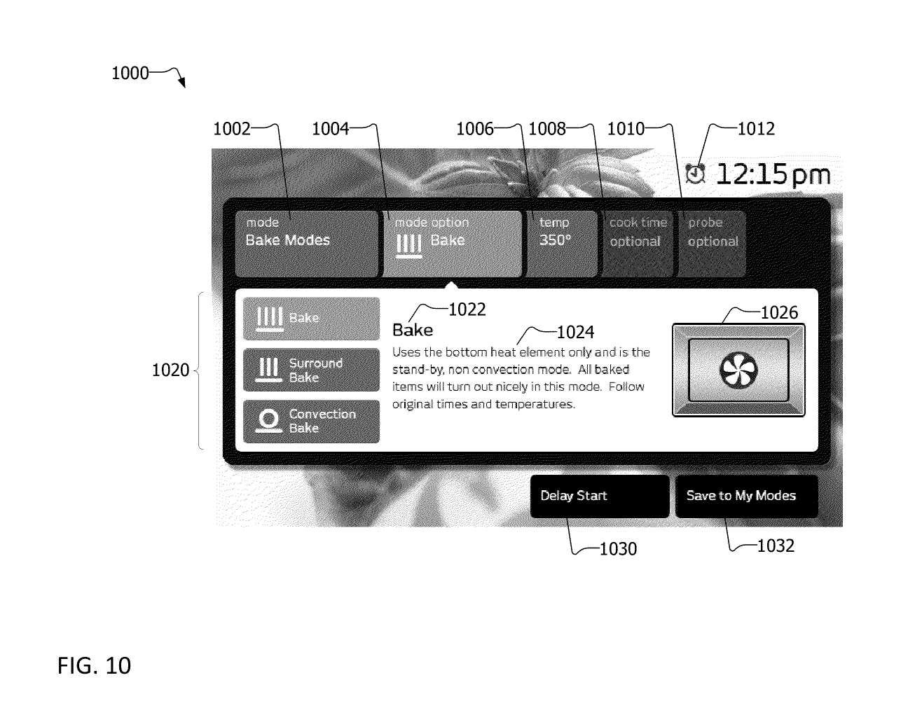

When the user selects “bake modes”, a top row of icons appears that, from left to right, display “bake modes” 902, “mode option” 904 and temp 906. The user interface may display a clock or other useful information in an area of the screen display, in this version of the system, in the top right corner. When the “mode option” 904 icon is selected, the cooking and controlling app provides the screen shown in FIG. 10. The bake modes screen 1000 provides a columnar iconic listing of mode option, in this example, bake modes 1010. The bake modes screen 1000 allows a user to select from three bake modes: bake, surround bake and convection bake. When a user selects via the touch screen one of the bake modes, the cooking and controlling app provides a text label 1022 and written description 1024 of the bake mode (mode option) is provided adjacent to the columnar iconic listing of mode options. In addition, a graphic 1026 showing the heating element that will be used in the mode option selection is displayed. These mode options 1020 may vary depending on the particular oven. When a selection is made, the user interface of the cooking and cleaning app changes the color of the selected mode option (bake mode) so that is stands out. In this version of the app, the color changes from grey to blue. When the user selects mode option “bake” a top row of icons appears that, from left to right, display “bake modes” 1002, “mode option” bake 1004, temp 350 1006, cook time optional 1008 and probe optional 1010. The user interface may display an alarm clock icon 1012 or other useful information in an area of the screen display, in this version of the system, in the top right corner. The alarm clock icon signifies that the oven is set to go on at some time in the future.

In addition, the bake modes mode option selection page provides the user the ability to save the particular cooking mode configuration as a favorite designated by the “save to my modes” icon 1032 or to delay start of cooking according to the current setting as designated by “delay start” icon 1030.

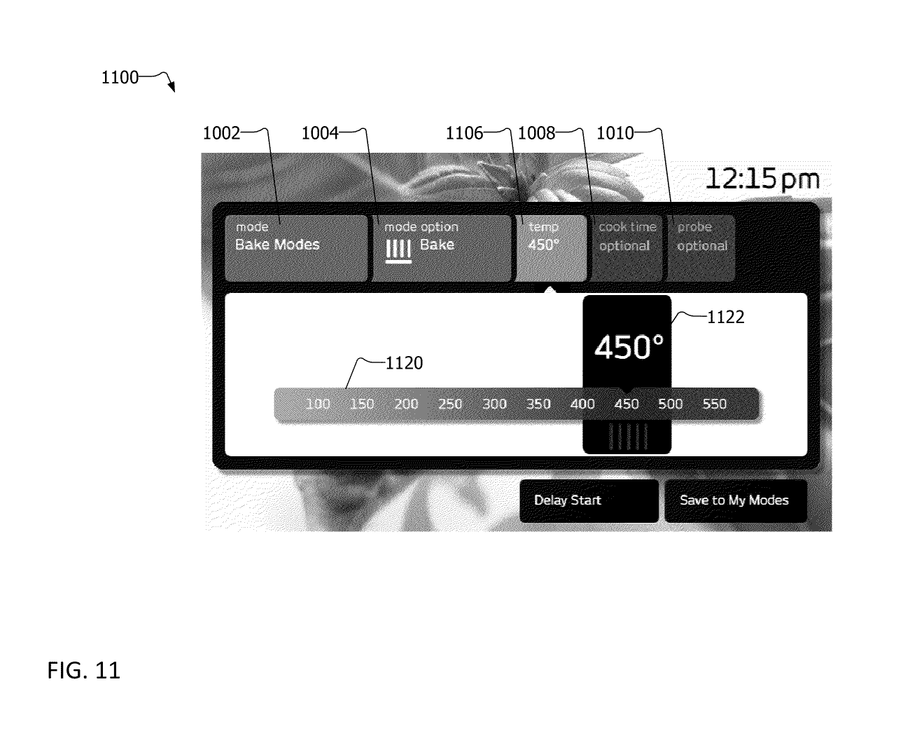

When the user selects the temp icon 1008, the temperature setting screen shown in FIG. 11 is provided. FIG. 11 shows temperature setting screen 1100 with temp 450 standing out in a contrasting color, here, blue versus grey along with a horizontal temperature selection bar 1120 and slider 1122. In this way the user can change the oven temperature for the particular mode option from the default temperature for that mode option by moving the slider via the touchscreen left and right until a desired temperature is reached.

In one version of the system, to start cooking according to the current selections, a capacitive touch button (adjacent to the Android display screen) labeled “start” must be activated (as shown in FIG. 4). In another embodiment, the cooking and controlling app provides a start button as an icon similar to a green circle or other graphic that says start. In another embodiment, both versions of the start method may be used.

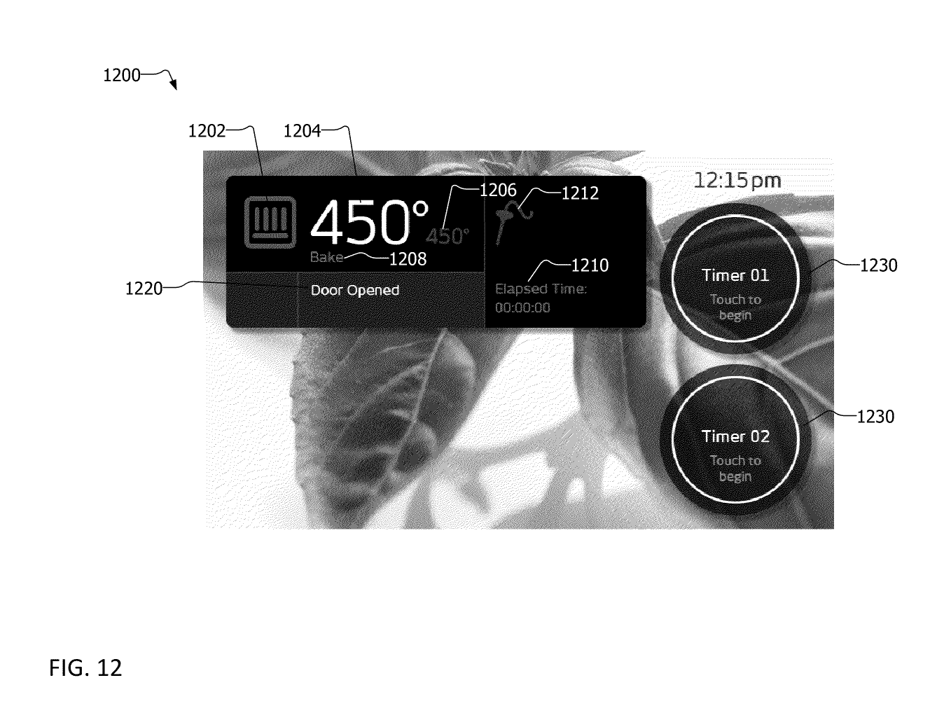

FIG. 12 shows a cooking screen provided by the cooking and controlling app after the oven has been started. The cooking screen 1200 shows an icon 1202 that represents the heating/cooking elements that are being used, along with a desired temperature 1204, current temperature 1206, and cooking mode 1208. An elapsed cooking time 1210 is also shown. The cooking screen 1200 shows a text message area that displays a current status of the cooking that may include instructions to the user of the oven. Here, the current status initially said “place item in oven”, now it says “opened door”, and next it will say “baking”. The cooking screen may include timer icons 1230 that allow a user of the Android controlled oven to set count down or cooking timers. An icon 1212 indicating whether a cooking probe is being used may also be included. Here the cooking probe is grey signifying that a probe is not being used.

When the cooking time has elapsed or a desired internal temperate has been reached using a probe, a cooking completed screen is provided and, depending on the user selection or the features of the cooking and controlling app, the oven may automatically put its cooking elements off while concurrently alerting the user of the cooking operation having been completed. The alert may be audible and may be visual. In addition, a text message or email note may be sent to a user of the Android controlled oven reporting the cooking status having been completed. In one version of the cooking and controlling app, the app notifies the user a few minutes (for example two or five minutes) before the anticipated or expected termination of the current cooking operation so that the user will be at the ready to remove the cooked item when the time has elapsed and/or the desired internal temperature had been reached.

Each of the various modes operates in a similar way to the baking mode shown in FIGS. 9 through 12 and described herein.

The cooking and controlling app includes as one of its modes a directed cooking feature called guided cooking. Guided cooking provides the user with a list of kinds of foods, and, based on the kinds of food selected and other consideration, sets the oven to achieve an appropriate amount of cooking for the selected food item. To enable guided cooking, a database, table or other form of data storage is used to store information. The stored information include some of the kinds of foods, weight of food, cooking times, cooking temperatures, item temperature, doneness (rare, medium, well, etc.), cooking modes (pure convention, convection bake, roast, broil, slow cook, etc.), and recommended pans (type and size; for example, 9″ pie pan, cooking stone, cookie sheet, 2.5 quart ceramic dish). The cooking and controlling app may also access and display enticing exemplary photos of the kinds of foods that may be prepared using guided cooking. This information may be included in the cooking and controlling app or may be stored in a storage memory on the Android board and accessed by the cooking and controlling app.

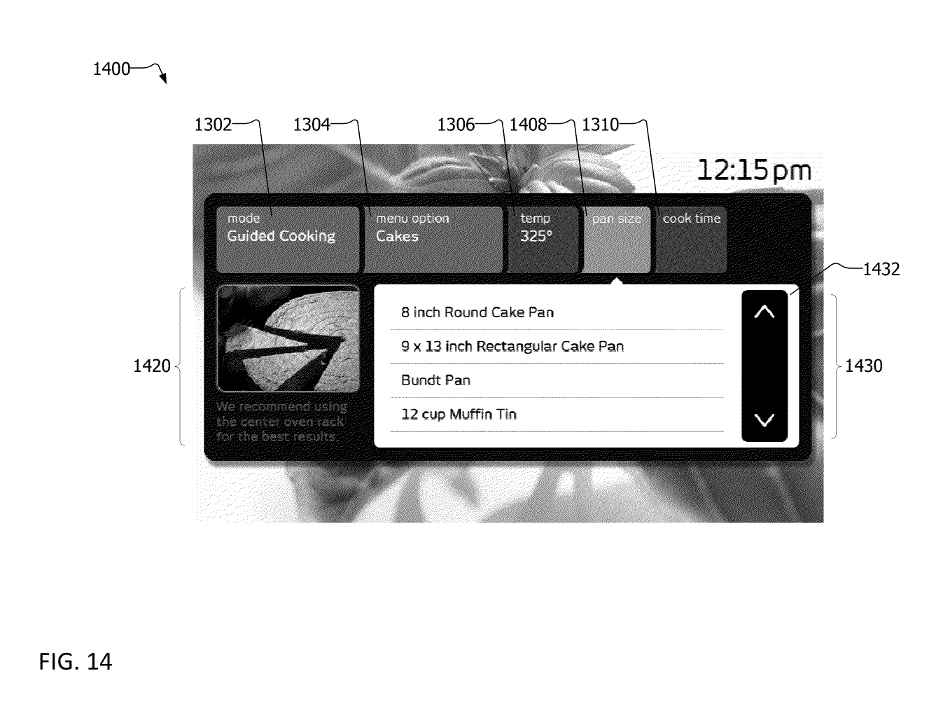

When a user selects guided cooking from the cooking modes 920 shown in FIG. 9, the cooking and controlling app provides a guided cooking screen. The guided cooking mode screen 1300 includes a listing of various kinds of foods in a left column 1320, and depending on the kind of food item selected from the left column 1320, the cooking and controlling app provides a sub-kind of food to be cooked in a second or right column 1330. The cooking and controlling app may provide onscreen vertical sliders 1322 and 1332 for a user to navigate among the kinds and sub-kinds of foods. In the example shown, the kind of food “bakery-dessert” and sub-kind cakes has been selected. The cooking and controlling app changes the color of the selected food kind and sub-kind so that they stand out. In this version of the app, the color changes from grey to blue. When the user selects sub-kind option “cakes” a top row of icons appears that, from left to right, display “guided cooking” mode 1302, “menu option” cakes 1304, temp 325 1306, pan size 1308 and cook time 1310. When the user selects “pan size” 1308 by tapping on the touchscreen display, cooking and controlling app updates the guided cooking screen as shown in FIG. 14.

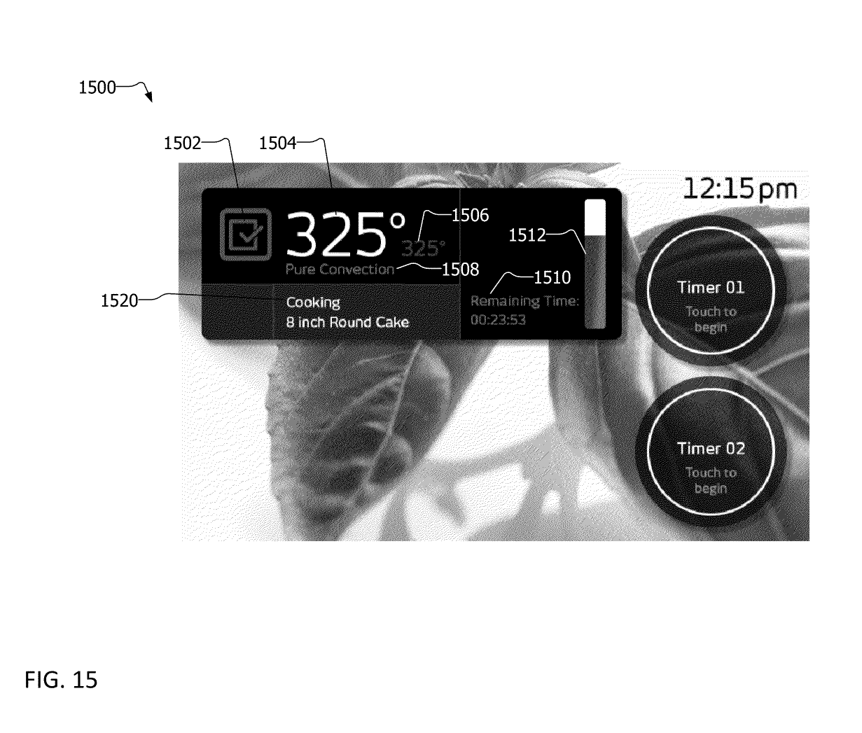

The updated guided cooking screen 1400 shown in FIG. 14 includes an indication that the pan size 1408 was selected as it is in a color or otherwise stands out from the other top row of horizontal icons. When the “pan size” 1408 is selected, the cooking and controlling app provides a graphical photo of an example of the selected item to be cooked along with a cooking recommendation 1420. A listing of pan sizes 1430 is also provided from which a user must choose. The cooking and controlling app may provide a vertical scroll bar or scrolling controls 1432 that allow a user to scroll through the list of kinds of baking pans the user will be using. After the user selects a particular baking pan kind/size, the cooking and controlling app provides a cooking screen as shown in FIG. 15

The cooking screen 1500 shown in FIG. 15 shows an icon 1502 that represents the heating/cooking elements that are being used, along with a desired temperature 1504, current temperature 1506, and cooking mode 1508 (in this example “pure convention”). A remaining cooking time 1510 is shown along with a vertical bar (akin to a bar graph) that visually indicates how much cooking time remains. The cooking screen 1500 shows a text message area that displays a current status of the cooking that may include instructions to the user of the oven. Here, the current status initially said “place item in oven” and “opened door”, and now it says “cooking, 8 inch round cake”.

When the cooking time has elapsed, a cooking completed screen is provided and, depending on the user selection or the features of the cooking and controlling app, the oven may automatically put its cooking elements off while concurrently alerting the user of the cooking operation having been completed. The alert may be audible and may be visual. In addition, a text message or email note may be sent to a user of the Android controlled oven reporting the cooking status having been completed. In one version of the cooking and controlling app, the app notifies the user a few minutes (for example two or five minutes) before the anticipated or expected termination of the current cooking operation so that the user will be at the ready to remove the cooked item when the time has elapsed. The same kinds of notifications may be sent when probe cooking is used.

The Android system and cooking and controlling app enable the oven to provide other benefits to the oven user. The cooking and controlling app may regularly back up customer configuration information to a manufacturer website or server via the Internet. This may be done so that when the Android components are replaced or the oven is upgraded to a newer version, the stored configuration data may be downloaded to configure the replacement components or oven.

In addition, the oven may be controlled and/or accessed by an oven access app on an oven user's mobile phone or tablet computing device. This may be considered remote access of the oven by a computing device (for example, a mobile phone, computer, or tablet) external to the oven. In conjunction with the cooking and controlling app included in the oven, a manufacturer may make an oven access app available to a user of the Android controlled oven. The oven access app may be available at an app store and downloaded to a phone or other mobile device or may be downloaded to a CHROME or WINDOWS 8 system which may be mobile or transportable or may be run on a desktop or non-mobile computing device (for example, a tablet). The oven access app may serve as a remote control to the oven.

The oven access app and the cooking and controlling app must be paired such that the oven access app is authorized to control and access the Android controlled oven. Stated another way, cooking and controlling app must authorize that the remote user of the oven access app should be given control of the oven. This may be achieved by the sharing of a key or code between users of both apps. In one embodiment, the mobile device or other device running the oven access app may be required to be on the same router or Wi-Fi access point as the oven. In another embodiment, the mobile device or other device running the oven access app may anywhere such that the oven may be controlled from remote locations.

In one embodiment, the cooking control chamber of the Android controlled oven is augmented with a camera. The cooking and controlling app may access the cooking chamber camera so that the oven user can take photos of items while they are cooking. The camera may be used to stream video of the items being cooked to a user of the oven access app. The oven access app on an oven user's mobile device may access the camera so that the user can view how the items being cooked look from the user's mobile device while the user is in another room of the house or on the patio or front porch. Similarly, an Android enabled television or set top box or BLU-RAY player (or other app enabled television) may run an app that allows an oven user to view oven and cooking information and images from the user's television. The user may also control certain features of the oven via the oven access app, including temperature setting and placing the oven off. In another embodiment, the camera may be IP address accessible so that the camera may be viewed by an Internet browser or other software at any location.

Closing Comments

Throughout this description, the embodiments and examples shown should be considered as exemplars, rather than limitations on the apparatus and procedures disclosed or claimed. Although many of the examples presented herein involve specific combinations of method acts or system elements, it should be understood that those acts and those elements may be combined in other ways to accomplish the same objectives. With regard to flowcharts, additional and fewer steps may be taken, and the steps as shown may be combined or further refined to achieve the methods described herein. Acts, elements and features discussed only in connection with one embodiment are not intended to be excluded from a similar role in other embodiments.

As used herein, “plurality” means two or more. As used herein, a “set” of items may include one or more of such items. As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims. Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. As used herein, “and/or” means that the listed items are alternatives, but the alternatives also include any combination of the listed items.

It is claimed:

1. A cooking oven comprising:
a cooking chamber including temperature sensors and a heating assembly;
a display panel having a control chamber behind, the display panel spanning a majority of a width of the cooking oven;
a touch screen assembly included in the control chamber, the touch screen assembly including a capacitive touch sensitive film and a liquid crystal display (LCD) screen, the touch screen assembly centered behind the display panel an including a portion of the display panel that matches the size of the liquid crystal display screen;
an Android board located in the control chamber, the Android board including a processor, a memory, a network communications unit, a memory chip having a version of an Android operating system stored thereon, and an audio speaker to play audio, the Android board coupled with the LCD screen to display video and coupled with the capacitive touch sensitive film to receive input when an oven user touches the display panel;
an oven interface board included in the control chamber and coupled with the Android board via a universal serial bus (USB connection), the oven interface board configured to receive oven control information from the Android board and provide the oven control information to the relay board;
the relay board included in the control chamber and coupled with the oven interface board, the temperature sensors and the heating assembly, the relay board configured to provide temperature information received from the temperature sensors to the oven interface board and to provide oven control information to the heating assembly.

2. The cooking oven of claim 1 further comprising:
a plurality of buttons silk screened on the display panel;
at least one capacitive touch board coupled with the oven interface board wherein the capacitive touch board is located on an opposite side of the display panel aligned with the plurality of buttons.

3. The cooking oven of claim 2 wherein the buttons include at least four of home, light, menu, back, start, continue, and cancel.

4. The cooking oven of claim 1 wherein the LCD screen and capacitive touch sensitive film are in a shape of a rectangle.

5. The cooking oven of claim 1 wherein the display panel is opaque but for the portion that corresponds to a size and a shape of the LCD screen.

6. The cooking oven of claim 1 wherein the display panel is a single piece of glass 3 mm thick.

7. The cooking oven of claim 1 wherein the Android board includes a software app which when executed causes the Android board to perform the following actions:
providing a graphical user interface prompting the user to select from a plurality of cooking modes;
receiving a cooking mode selection from the user;
providing a graphical user interface prompting the user to select or confirm a cooking temperature;
receiving a cooking temperature selection from the user;
providing the cooking temperature and the cooking mode to the oven interface to initiate cooking.

8. The cooking oven of claim 7 wherein the cooking modes include at least three of bake, broil, pure convection, dehydrate, defrost, warm/hold, proof, self clean, slow cook and guided cooking.

9. The cooking oven of claim 8 wherein when the cooking mode selection is guided cooking the software app causes the Android board to perform further actions including:
providing a graphical user interface prompting the user to select from a plurality of food kinds;
receiving a food kind selection from the user;
based on the food kind selection, providing a graphical user interface prompting the user to select from a plurality of food sub-kinds;
based on the food sub-kind selection, providing at least two of recommended cooking time, cooking temperature, food temperature, food weight and pan to the user.

10. The cooking oven of claim 7 wherein the software app causes the Android board to perform further actions including:
receiving a connection request from a remote app operating on a device external to the cooking oven;
authorizing a connection with the remote app;
receiving cooking commands from the remote app;
providing the cooking commands to the oven interface board to initiate cooking.

11. A cooking oven comprising:
a cooking chamber including temperature sensors and a heating assembly;
a display panel spanning a majority of a width of the cooking oven;
a touch screen assembly including a capacitive touch sensitive film and a liquid crystal display (LCD) screen, the touch screen assembly centered behind the display panel and including a portion of the display panel that matches a size of the LCD screen;
an Android board located in the control chamber, the Android board including a processor, a memory, a network communications unit, a memory chip having a version of an Android operating system stored thereon, and an audio speaker to play audio, the Android board coupled with the LCD screen to display video and coupled with the capacitive touch sensitive film to receive input when an oven user touches the display panel;
wherein the Android board includes a software app which when executed causes the Android board to perform the following actions:
providing a graphical user interface prompting the user to select from a plurality of cooking modes;
receiving a cooking mode selection from the user;
providing a graphical user interface prompting the user to select or confirm a cooking temperature;
receiving a cooking temperature selection from the user;
providing the cooking temperature and the cooking mode to the heating assembly to initiate cooking.

12. The cooking oven of claim 11 further comprising:
a plurality of buttons silk screened on the display panel;
at least one capacitive touch board wherein the capacitive touch board is located on an opposite side of the display panel aligned with the plurality of buttons.

13. The cooking oven of claim 12 wherein the buttons include at least four of home, light, menu, back, start, continue, and cancel.

14. The cooking oven of claim 11 wherein the LCD screen and capacitive touch sensitive film are in a shape of a rectangle.

15. The cooking oven of claim 11 wherein the display panel is opaque but for the portion that corresponds to a size and a shape of the LCD screen.

16. The cooking oven of claim 11 wherein the display panel is a single piece of glass 3 mm thick.

17. The cooking oven of claim 11 wherein the cooking modes include at least three of bake, broil, pure convection, dehydrate, defrost, warm/hold, proof, self clean, slow cook and guided cooking.

18. The cooking oven of claim 17 wherein when the cooking mode selection is guided cooking the software app causes the Android board to perform further actions including:
providing a graphical user interface prompting the user to select from a plurality of food kinds;
receiving a food kind selection from the user;
based on the food kind selection, providing a graphical user interface prompting the user to select from a plurality of food sub-kinds;
based on the food sub-kind selection, providing to the user at least two of cooking time, cooking temperature, food temperature, food weight and pan.

19. The cooking oven of claim 11 wherein the software app causes the Android board to perform further actions including:
determining that cooking has been completed or is nearing completion;
notifying the user by one of text message or email that the cooking has completed or is nearing completion.

20. The cooking oven of claim 11 wherein the software app causes the Android board to perform further actions including:
receiving a connection request from a remote app operating on a computing device external to the cooking oven;
authorizing a connection with the remote app;
receiving cooking commands from the remote app;
providing the cooking commands to the heating assembly to initiate cooking.
